(19) United States
(12) Patent Application Publication
(10) Pub. No.: US 2026/0062883 A1
(43) Pub. Date: Mar. 5, 2026

(54) ILLUMINATED DOCK BUMPER SYSTEM

(71) Applicant: HENDREN PLASTICS INC., Gravette, AR (US)

(72) Inventor: Jim Hendren, Gravette, AR (US)

(21) Appl. No.: 19/188,279

(22) Filed: Apr. 24, 2025

Related U.S. Application Data
(60) Provisional application No. 63/689,988, filed on Sep. 3, 2024.

(51) Int. Cl. E02B 3/26; F21V 33/00; F21W 111/04; F21Y 115/10

(52) U.S. Cl. CPC E02B 3/26; F21V 33/0076; F21W 2111/04; F21Y 2115/10

(57) ABSTRACT

An illuminated dock bumper system for improving visibility and safety in marine and vehicle docking environments including a bumper member having a channel. The bumper member is secured to an edge of a dock. The channel is exposed to receive a lighting system. The lighting system mounts in a flush within the channel ensuring that the lighting system is prevented from damage. The illuminated dock bumper system includes a control unit operatively connecting the lighting system. The control unit is operated either manually, or remotely via an electronic device. The control unit allows an operator to adjust colors and brightness of the lighting system. The illuminated dock bumper system allows the operator to locate the edge of the dock at night or in low-light conditions using illumination provided by the lighting system. The bumper member offers impact protection for both vehicles and the dock.

### CROSS-REFERENCE TO RELATED APPLICATIONS

The present application claims priority to a U.S. Provisional Application No. 63/689,988, filed September 3, 2024; all of which is incorporated herein in its entirety and referenced thereto.

### BACKGROUND OF THE INVENTION

### FIELD OF THE INVENTION

The present invention relates to lighting systems, and in particular, relates to an illuminated dock bumper system for improving the visibility of a dock and preventing damage to vehicles and the dock itself.

### DESCRIPTION OF THE PRIOR ART

It is known that dock bumpers are used in various docking environments including boat marinas, truck loading bays, and other vehicle docks. The dock bumpers are used to protect both docking vehicle/boat and the dock itself from damage during docking maneuvers. The dock bumpers absorb impact and act as protective barriers between the dock and the vehicle/boat. Although the dock bumpers offer physical protection, they are not visible at night or in low-light conditions such as during inclement weather conditions.

In order to address the visibility issues, several attempts have been made in the past to provide lighting systems at the docks or dock bumpers. One such example is disclosed in a U.S. Patent No. 6,095,074, entitled “Illuminated dock bumper” (“the ‘074 Patent”). The ‘074 Patent discloses a bumper for a boat dock which is durable, resilient and visible at night. The bumper is constructed of an expanded polymer such as polyethylene or polypropylene. The bumper is preferably made of translucent polyethylene foam with a density of between 2 and 4 pounds per cubic foot. When polyethylene foam is subjected to impact, it absorbs the force of the impact and returns to its original shape. The present invention includes a light for illumination of the bumper itself or illumination of an area immediately adjacent to the bumper. A slot in the bumper is provided for accepting the illumination source. If the bumper is translucent, as with white polyethylene foam, the illumination source may be inserted into the back of the bumper such that light is emitted through the front of the bumper. If the bumper is opaque, the illumination source may be inserted into a slot in the bottom of the bumper so that the light is emitted from the bottom of the bumper. The illumination source may be controlled by a radio frequency switch or by a timer.

Another example is disclosed in a U.S. Publication No. 20060130727, entitled “Illuminated dock bumper” (“the ‘727 Publication”). The ‘727 Publication discloses an illuminated dock bumper formed of a semi-rigid and translucent plastic shell and containing a self-contained, independent electrical lighting system therein. The translucent plastic shell may be white or may be tinted as desired, e.g., red or green for navigational purposes, etc. A solar cell charges a battery during periods of daylight or high illumination, with a photocell closing a circuit to turn on a light source to radiate light through the translucent shell during periods of darkness or low ambient lighting. The system may alternatively be remotely activated and/or may operate intermittently, as desired. The bumper includes a sleeve, which fits over a conventional dock piling or the like, allowing the device to be removably installed over posts, pilings, and similar structures as desired. Different configurations or adapters allow the device to be installed upon different diameters and shapes of dock posts, as required.

Another example is disclosed in a U.S. Patent No. 9,840,820, entitled “Light altering bumper device” (“the ‘820 Patent”). The ‘820 Patent discloses an integrally formed, light altering bumper designed to amplify amounts of visible light from a self-contained, integrated light source. The present invention is generally an illuminating dock bumper for attachment to either a dock or a dock vehicle made from a spine member; a lobe member; and a protective housing located within the recessed portion of the spine member for receiving an elongate light source therewithin, the light from the light source to illuminate the bumper in turn. The protective housing has a linear concave light refractor disposed thereon, the linear concave light refractor being a centrally-disposed, uniform, elongate concave depression extending along the length of the protective housing.

Although the above discussed disclosures are useful, they have few problems. For example, the above disclosures present the lighting systems as separate components from the dock bumpers. As a result, it becomes very difficult to install, and perform maintenance in case the lighting systems fail. Further, the lighting systems are exposed to the environment, which may lead to damage by the boats/vehicle upon coming in contact. Further, the lighting systems installed as separate components may result in exposed wirings which might be susceptible to water damage, and difficulty in achieving uniform illumination along dock edges.

Therefore, there is a need in the art to provide an improved illuminated dock bumper system seamlessly integrating the lighting system in order to provide physical protection and enhanced visibility along the dock edges.

### SUMMARY OF THE INVENTION

It is an object of the present invention to provide an illuminated dock bumper system to improve dock visibility and safety for vehicles/boats and docks at night or in low-light conditions.

It is another object of the present invention to provide an illuminated dock bumper system having a bumper member integrating a channel for receiving a lighting system. The channel incorporates unique “lock in” features to keep the lighting system secure via a series of tabs integrated into the channel.

It is another object of the present invention to provide a lighting system implementing a safe and low-voltage electrical system suitable for outdoor maritime use.

In order to achieve one or more objects, the present subject matter provides an illuminated dock bumper system for improving visibility and safety in marine and vehicle/boat docking environments. The illuminated dock bumper system includes a bumper member having a channel. The bumper member is secured to an edge of a dock/marina. The bumper member is capable of absorbing the force of the impact when a vehicle/boat comes in contact with it during docking maneuvers. The channel is exposed to receive a lighting system. The lighting system mounts in a flush or slightly recessed position within the channel ensuring that the lighting system is prevented from damage. The illuminated dock bumper system includes a control unit operatively connecting the lighting system. The control unit is operated either manually, or remotely via an electronic device. The control unit allows an operator to adjust colors and brightness of the lighting system. The lighting system illuminates offering visibility of the dock to the operator from a distance. This helps the operator to dock the vehicle/boat during the night or in low-light conditions

In one advantageous feature of the present subject matter, the illuminated dock bumper system combines dock and vehicle/boat protection with the bumper member while integrating the lighting feature to enhance the safety and visibility in docking environments.

In another advantageous feature of the present subject matter, the channel runs along the length of the bumper member and receives the flexible lighting system. The lighting system fits in flush or slightly recessed position within the channel. The channel protects the lighting system from impact damage during docking maneuvers.

In another advantageous feature of the present subject matter, the lighting system operatively connects to a control unit incorporating Ground Fault Current Interruption (GFCI) and overcurrent protection, ensuring safe operation in maritime use.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

FIG. 1 is an environment in which an illuminated dock bumper system implements, in accordance with one exemplary embodiment of the present subject matter.

FIG. 2A and FIG. 2B show a perspective view and a front elevational view, respectively of the illuminated dock bumper system, in accordance with one embodiment of the present subject matter.

FIG. 3 is a perspective view of the illuminated dock bumper system receiving a lighting system, in accordance with one embodiment of the present subject matter.

FIG. 4 shows the feature of the lighting system illuminating, in accordance with one embodiment of the present subject matter.

FIG. 5 shows the operational feature of the illuminated dock bumper system, in accordance with one exemplary embodiment of the present subject matter.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed illuminated dock bumper system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed illuminated dock bumper system.

In the present specification, an embodiment showing a singular component should not be considered limiting. Rather, the subject matter preferably encompasses other embodiments including a plurality of the same component, and vice versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes an illuminated dock bumper system, it is to be further understood that numerous changes may arise in the details of the embodiments of the illuminated dock bumper system. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

Various features and embodiments of the illuminated dock bumper system are explained in conjunction with the description of FIGUREs (FIGs.) 1-5.

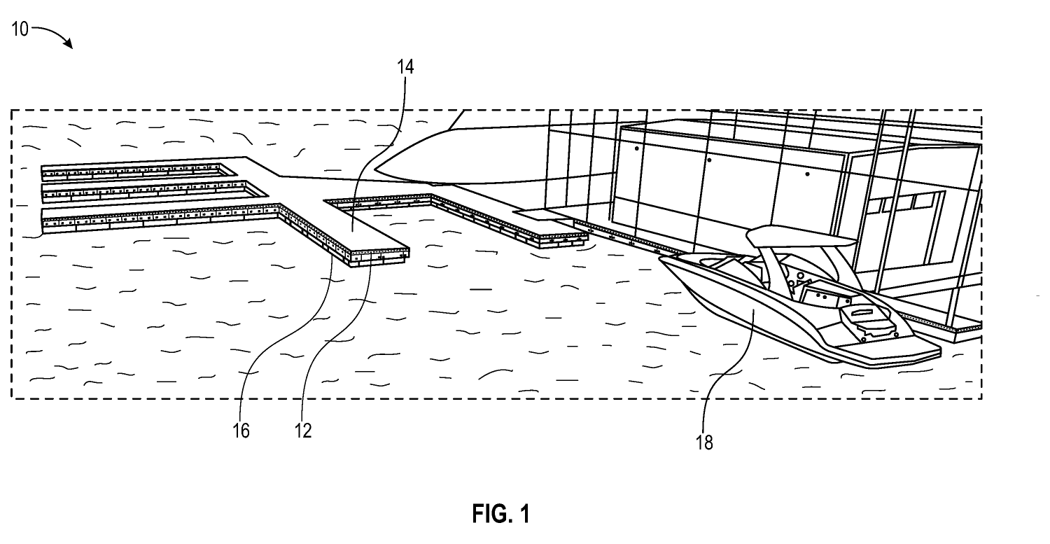

F IG. 1 shows an environment 10 in which an illuminated dock bumper system 12 implements, in accordance with one exemplary embodiment of the present subject matter. Illuminated dock bumper system 12 mounts at edges 16 of a dock/marina 14 allowing boats or vehicles 18 to visualize dock 14 at night or in low-light conditions such as during inclement weather conditions. Here, dock 14 indicates a marina or basin with moorings and supplies for yachts and/or small boats 18, as illustrated in FIG. 1. Optionally, illuminated dock bumper system 12 may be implemented to protect both a docking (land) vehicle such as a trailer, loading dock equipment, and the dock/warehouse wall itself from damage during docking maneuvers. For example, illuminated dock bumper system 12 may be implemented as a loading dock bumper at the edges of truck loading bays (similar to edge 16 of dock 14) to protect a building or structure from the impact as vehicle/truck 18 is backed into position. Similarly, illuminated dock bumper system 12 may be implemented as any other vehicle dock dumper depending on the need without departing from the scope of the present subject matter.

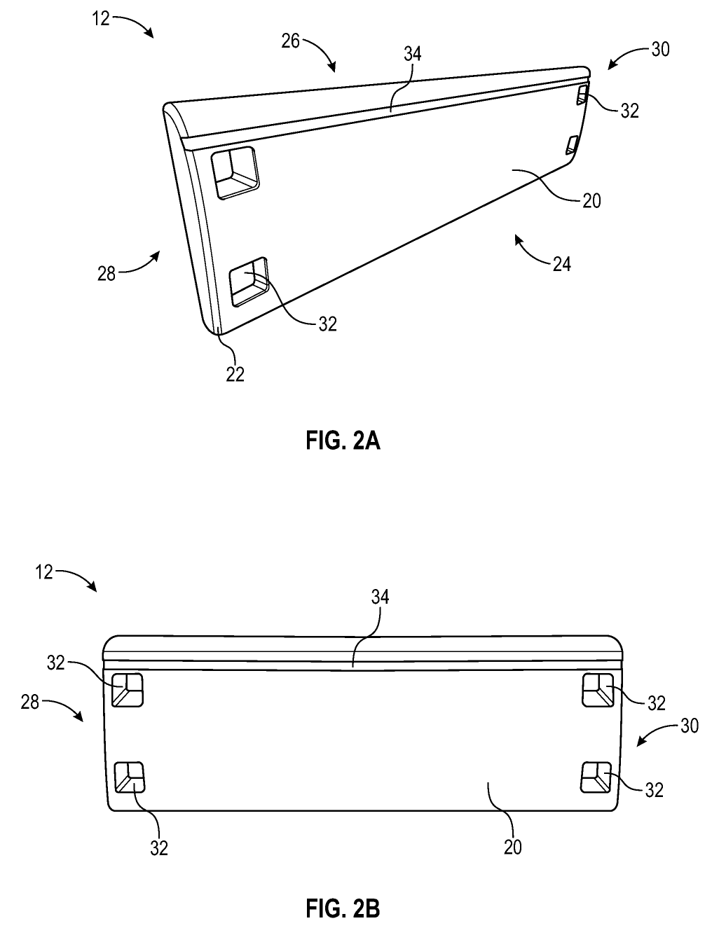

FIG. 2A and FIG. 2B show a perspective view and a front elevational view, respectively of illuminated dock bumper system 12, in accordance with one embodiment of the present subject matter. Illuminated dock bumper system 12 includes a bumper member 20. Bumper member 20 is made of an expandable polymer foam (such as polyethylene or polypropylene), wood, metal, plastic or any other suitable material. Bumper member 20 is capable of absorbing the force of the impact when vehicle/boat 18 comes in contact with it during docking maneuvers. Bumper member 20 comes in a rectangular, square, L-shape or any other configuration. In other words, bumper member 20 comes as a straight piece, corner piece, splice piece or trim piece to allow for a secure way to mount in any configuration around edge 16 of dock or marina 14. The present description is explained considering that bumper member 20 comes in a rectangular configuration. In one example, bumper member 20 has curved edges/corners or curvature 22. Edges and/or corners 22 are rounded/curved to give a smooth appearance to bumper member 20. Further, curved edges/corners 22 accommodate absorption of impact from vehicle/boat 18 from all directions.

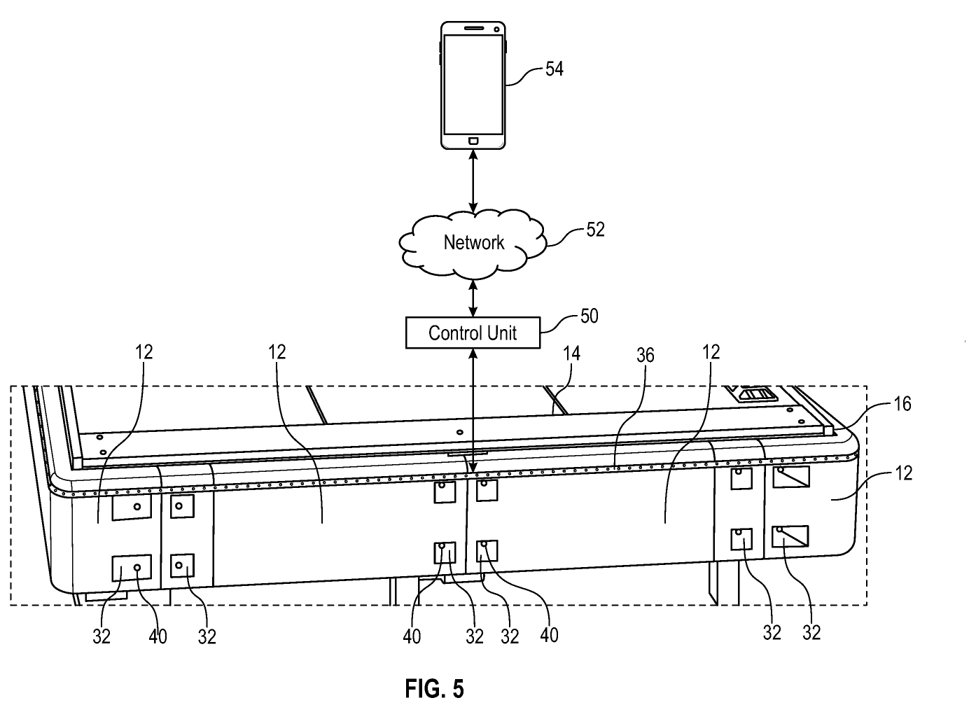

Bumper member 20 has a first end 24, a second end 26, a first side 28 and a second side 30. First end 24 indicates a front end, and second end 26 indicates a rear end, or vice versa of bumper member 20. First side 28 indicates a right side, and second side 30 indicates a left side, or vice versa of bumper member 20. In the present subject matter, bumper member 20 is formed as a deformable structure constructed as a unitary/single bumper member 20, in which first end 24 is used as impact receiving surface, and second end 26 is used as a connecting surface securing to edge 16 of dock/marina 14. First side 28 and second side 30 extend parallelly from one another, and perpendicularly to first end 24 and second end 26. First side 28 and second side 30 are conformed to accommodate similar and adjacent bumper member 20 such that a plurality of bumper members 20 can be arranged in series (side-by-side), as shown in FIGS. 1 and 5 along edge 16 of dock/marina 14.

In one example, bumper member 20 has a length of forty-eight (48) inches, height of twelve (12) inches, and a thickness of two and half (2.5) inches. However, a person skilled in the art understands that it is possible to provide bumper member 20 in any other configuration and size without departing from the scope of the present subject matter.

In one implementation, bumper member 20 includes a plurality of slots 32. In one example, slots 32 are provided at proximate edges 22 of bumper member 20. In another example, slots 32 are provided at the center of bumper member 20 or combination of center and edges of bumper member 20, depending on the need. Present subject matter presents slots 32 provided proximately to the edges or corners 22 of bumper member 20. However, it is possible to provide slots 32 at different positions without departing from the scope of the present subject matter.

Further, bumper member 20 includes a channel 34. Channel 34 is formed along the length (or partial length) of bumper member 20, as shown in FIG. 2A, for example. It should be understood that channel 34 is integrated into the plastic molding process of bumper member 20. Optionally, channel 34 is formed by chipping away a portion of material from bumper member 20. Channel 34 comes in a straight, curved, wave pattern, zigzag or any other shape depending on the need. In one example, channel 34 includes a series of molded tabs to hold a lighting source securely in place. In one example, channel 34 is provided at the top and at first end 24 of bumper member 20 running in a horizontal (from first side 28 to second side 30) configuration. In one example, channel 34 is provided at the center of bumper member 20. In another example, channel 34 is provided at both top and bottom of bumper member 20. In yet another example, channel 34 is provided at first end 24 of bumper member 20 at one of top, bottom and center, or combination thereof. Optionally, channel 34 comes in a vertical configuration. It is preferable to provide channel 34 in horizontal configuration so that when plurality of bumper members 20 are placed in series, channels 34 in plurality of bumper members 20 align in a straight line configuration, as shown in FIG. 5, for example.

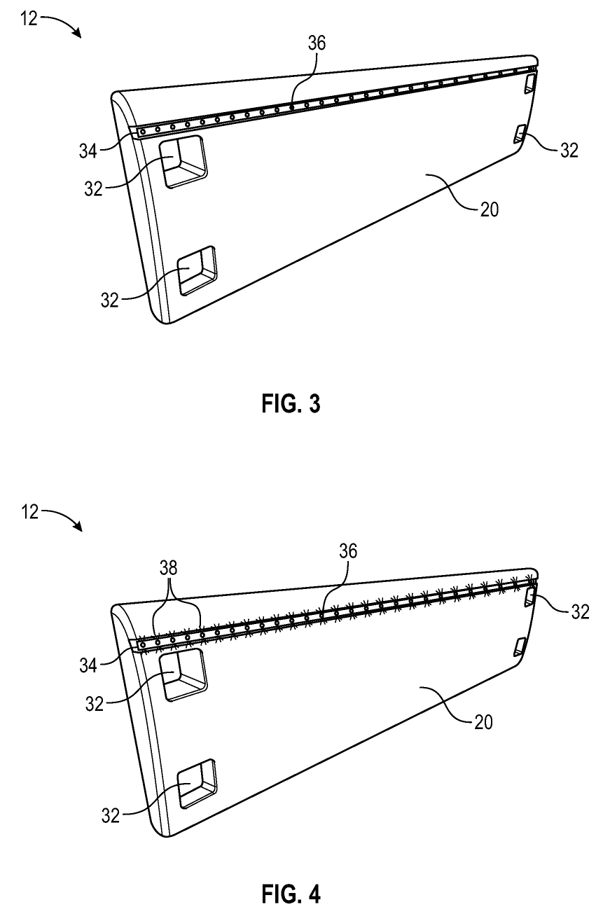

In the present subject matter, illuminated dock bumper system 12 includes a lighting system 36. Lighting system 36 indicates an illumination member or illumination source such as a light-emitting diode (LED) strip light. Lighting system 36 has a flexible circuit board populated with a plurality of LED lights configured to offer lighting in a variety of colors and with varied brightness. In the present subject matter, lighting system 36 is inserted in channel 34, as shown in FIG. 3. In one example, lighting system 36 is pressed into channel 34. In another example, lighting system 36 is removably secured in channel 34 using known mechanisms such as adhesive, fastening mechanism, etc. As channel 34 is formed within bumper member 20, lighting system 36 is positioned in a flush manner such that lighting system 36 does not protrude out from the surface of bumper member 20 at first end 24. The flush design ensures that lighting system 36 does not get damaged when boat/vehicle 18 is docked against illuminated dock bumper system 12. Lighting system 36 is configured to provide illumination 38, as shown in FIG. 4. In one example, lighting system 36 is configured to provide illumination 38 with sufficient intensity to project light in different color from first end 24.

Now referring to FIG. 5, operational feature of illuminated dock bumper system 12 is explained, in accordance with one exemplary embodiment of the present subject matter. As specified above, plurality of illuminated dock bumper systems 12 is connected in series at edges 16 of dock 14. Here, (second end 26 of) bumper members 20 are connected to edges 16 of dock 14 exposing first end 24. In one example, bumper member 20 are connected to dock 14 via connectors 40 such as fasteners. Here, connectors 40 are inserted through slots 32 to connect bumper members 20 to dock 14. Optionally, bumper member 20 is connected to dock/marina 14 using adhesive or any other known connecting mechanisms.

In one implementation, lighting system 36 operatively connects to a control unit or control system 50. Control unit 50 is designed with Ground Fault Current Interruption (GFCI) and over current protection for maximum safety. The output of control unit 50 is 48 Volts DC maximum (low voltage) to ensure safety in an outdoor maritime environment. In other words, control unit 50 is configured at low wattage to prevent an overload of electric circuits at dock 14.

In one embodiment, control unit 50 acts as a manual switch to modify the color and illumination/intensity of lighting system 36. In one example, control unit 50 is provided with a timer to actuate lighting system 36 to provide illumination 38 at predefined time intervals or particular time of the day/night. In another embodiment, control unit 50 integrates a transceiver (not shown) for operatively and communicatively connecting to an electronic device 54 via a network 52 to allow an operator to operate lighting system 36 remotely. Network 52 includes a wireless network, a wired network or a combination thereof. Network 52 can be implemented as one of the different types of networks, such as intranet, local area network (LAN), wide area network (WAN), the internet, and the like. Network 16 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Electronic device 54 includes, but not limited to a mobile phone, tablet, smart watch, radio frequency switch, etc. Electronic device 54 is operated by an operator (not shown) of vehicle/boat 18. In one exemplary scenario, the operator uses electronic device 54 to operate lighting system 36 remotely from dock 14 . As the operator approaches dock 14, he/she may operate electronic device 54 to transmit a signal to control unit 50 to actuate lighting system 36. In one example, the operator changes the color and brightness of lighting system 36 based on the need using options provided in electronic device 54. This way, the operator finds it easy to identify dock 14 at night or in low-light conditions such as during inclement weather condition for safely docking vehicle/boat 18.

The presently disclosed illuminated dock bumper system provides several advantages over the prior art. The illuminated dock bumper system integrates a precision-molded channel to securely hold and protect the lighting system within the bumper member. This ensures the lighting system does not protrude from the surface of the bumper member and prevents the lighting system from getting damaged when boats/vehicles dock against the illuminated dock bumper system. The illuminated dock bumper system can be operated manually or even remotely to illuminate, change color, and adjust the brightness of the lighting system to provide visibility during low-light conditions allowing the boat operators to easily identify the dock/marina. The visibility offered by the lighting system reduces the risk of accidents while enhancing the safety of the boat/vehicle and the dock itself. Further, the lighting system integrates Ground Fault Current Interruption (GFCI) and overcurrent protection to ensure safe operation in maritime environments. This reduces the risks associated with electrical hazards in docking environments.

A person skilled in the art appreciates that the illuminated dock bumper system can come in a variety of shapes and sizes depending on the need and comfort of the user. Further, many changes in the design and placement of components may take place without deviating from the scope of the presently disclosed illuminated dock bumper system.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An illuminated dock bumper system, comprising:
a bumper member secured to an edge of a dock;
a channel formed within said bumper member; and
a lighting system positioned in said channel,
wherein said lighting system illuminates and enhances visibility of said dock during docking maneuvers.

2. The illuminated dock bumper system of claim 1, wherein said channel extends along a portion of the length of said bumper member.

3. The illuminated dock bumper system of claim 1, wherein said bumper member comprises slots, and wherein said slots receive connectors to secure said bumper member to said edge of said dock.

4. The illuminated dock bumper system of claim 1, wherein said lighting system is positioned within said channel in a flush manner.

5. The illuminated dock bumper system of claim 1, wherein said bumper member is formed of an expandable polymer foam, and wherein said bumper member absorbs impact from a vehicle during docking.

6. The illuminated dock bumper system of claim 1, further comprises a control unit operatively connecting to said lighting system, wherein said control unit modifies at least one of color and intensity of the illumination provided by said lighting system.

7. The illuminated dock bumper system of claim 6, wherein said control unit selectively activates said lighting system at predefined time intervals.

8. The illuminated dock bumper system of claim 6, wherein said control unit communicatively connects to an electronic device, and wherein said electronic device remotely operates said lighting system.

9. The illuminated dock bumper system of claim 1, wherein said lighting system comprises a light-emitting diode (LED) strip.

10. The illuminated dock bumper system of claim 6, wherein said control unit comprises a Ground Fault Current Interruption (GFCI) protection system to provide low voltage output to said lighting system.

11. The illuminated dock bumper system of claim 1, wherein said bumper member comprises curved edges, and wherein said curved edges absorb impact from sides during said docking maneuvers.

12. An illuminated dock bumper system, comprising:
a bumper member secured to an edge of a dock;
a channel formed within said bumper member;
a lighting system positioned in said channel;
a control unit operatively connected to said lighting system;
an electronic device communicatively connected to said control unit,
wherein said electronic device operates said lighting system via said control unit to illuminate and enhance visibility of said dock during docking maneuvers.

13. The illuminated dock bumper system of claim 12, wherein said channel extends along a portion of the length of said bumper member.

14. The illuminated dock bumper system of claim 12, wherein said bumper member comprises slots, and wherein said slots receive connectors to secure said bumper member to said edge of said dock.

15. The illuminated dock bumper system of claim 12, wherein said lighting system is positioned within said channel in a flush manner.

16. The illuminated dock bumper system of claim 12, wherein said bumper member comprises curved edges, wherein said curved edges absorb impact from sides during said docking maneuvers.

17. The illuminated dock bumper system of claim 12, wherein said electronic device selectively activates said lighting system at predefined time intervals.

18. The illuminated dock bumper system of claim 12, wherein said lighting system comprises a light-emitting diode (LED) strip.

19. The illuminated dock bumper system of claim 12, wherein said control unit comprises a Ground Fault Current Interruption (GFCI) protection system to provide low voltage output to said lighting system.

20. A method of providing an illuminated dock bumper system for illuminating a dock, said method comprising the steps of:
providing a bumper member secured to an edge of a dock;
providing a channel formed within said bumper member;
providing a lighting system positioned in said channel; and
illuminating said lighting system for enhancing visibility of said dock during docking maneuvers.
